(19) United States
(12) Patent Application Publication
(10) Pub. No.: US 2014/0139431 A1
(43) Pub. Date: May 22, 2014

(54) METHOD FOR DISPLAYING IMAGES OF TOUCH CONTROL DEVICE ON EXTERNAL DISPLAY DEVICE

(71) Applicant: HTC CORPORATION, Taoyuan County (TW)

(72) Inventors: Chieh-Chih Tseng, Taoyuan County (TW); Jenn-Wein Wu, Taoyuan County (TW); Hsin-Ti Chueh, Taoyuan County (TW)

(73) Assignee: HTC CORPORATION, Taoyuan County (TW)

(21) Appl. No.: 13/684,099

(22) Filed: Nov. 21, 2012

(51) Int. Cl. G06F 3/041

(52) U.S. Cl. CPC G06F 3/041
USPC 345/158; 345/173

(57) ABSTRACT

The present invention provides a method for displaying images of a touch control device on an external display device. The method comprises providing a graphical icon on the image displayed on the external display device; providing a control interface for controlling the graphical icon on the touch control device; receiving a control signal from the control interface; and performing an operation corresponding to the control signal.

### BACKGROUND OF THE INVENTION

1. Field of the Invention

The invention relates to a method for displaying images of a touch control device on an external display device, and more particularly, to a method for controlling a graphical icon in the displayed images according to control input received from the touch control device.

2. Description of the Prior Art

As related technology keeps improving, conventional feature phones are gradually replaced by touch-controlled smart phones embedded with various kinds of application programs. A screen of a touch-controlled smart phone is generally small, such that when a user of the smart phone tries to demonstrate an image displayed on the smart phone to other people, the user may couple the smart phone to an external display device via a wireless network or a signal cable to transmit the image of the smart phone to the external display device. The operation system of a smart phone normally supports touch control operations, such as scrolling, tapping, zoom-in, zoom-out and/or other gestures. In the condition that user wishes to perform operation on certain part of the displayed content, for example directing to another link on a website, user might need to scroll the webpage to proper position, zoom in the displayed image so that it would be easier to tap on the link. However, it often occurs that another nearby link may be selected instead of the intended link due to the touch screen wrongly identifies the position of the tap input. As a result, it causes inconvenience of controlling operation of the smart phone.

### SUMMARY OF THE INVENTION

One embodiment of the invention discloses a method for displaying images of a touch control device on an external display device. The method comprises providing a graphical icon on the image displayed on the external display device; providing a control interface for controlling the graphical icon on the touch control device; receiving a control signal from the control interface; and performing an operation corresponding to the control signal.

Another embodiment of the invention discloses a touch control device comprising: a touch input interface unit, configured to receive a touch input; a processing unit, configured to process a control signal corresponding to the touch input; and an image processing unit, configured to provide an image displayed with a graphical icon; wherein the graphical icon is controlled according to the control signal.

Yet another embodiment of the invention discloses a method for displaying images of a touch control device on an external display device, comprising: detecting a connection of the touch control device to the external device; and switching from a first display mode to a second display mode for displaying an image on the external device in response to the connection being detected; wherein the second display mode provides additional graphics user interface not supported in the first display mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram showing a touch control device 100 of the present invention.

FIG. 2 illustrates a method for displaying images of a touch control device on an external display device according to an embodiment of the invention.

FIG. 3 illustrates an embodiment of display images in external display mode of the invention.

FIG. 4 illustrates an embodiment of controlling display images in external display mode.

FIG. 5 illustrates a block diagram of a touch control device according to an embodiment of the invention.

FIG. 6 illustrates another embodiment of display images in external display mode of the invention.

FIG. 7 illustrates a method for displaying images of a touch control device on an external display device according to an embodiment of the invention.

FIG. 8 depicts a method for displaying images of a touch control device on an external display device according to another embodiment of the invention.

### DETAILED DESCRIPTION

The invention provides an intuitive way for controlling display contents of an external display device connected to a touch control device. By adding additional graphics control interface to the original display image, the user may use, for example a cursor, to browse or select particular content just as using a personal computer. The touch screen may be configured as a touch pad for controlling the graphics control interface.

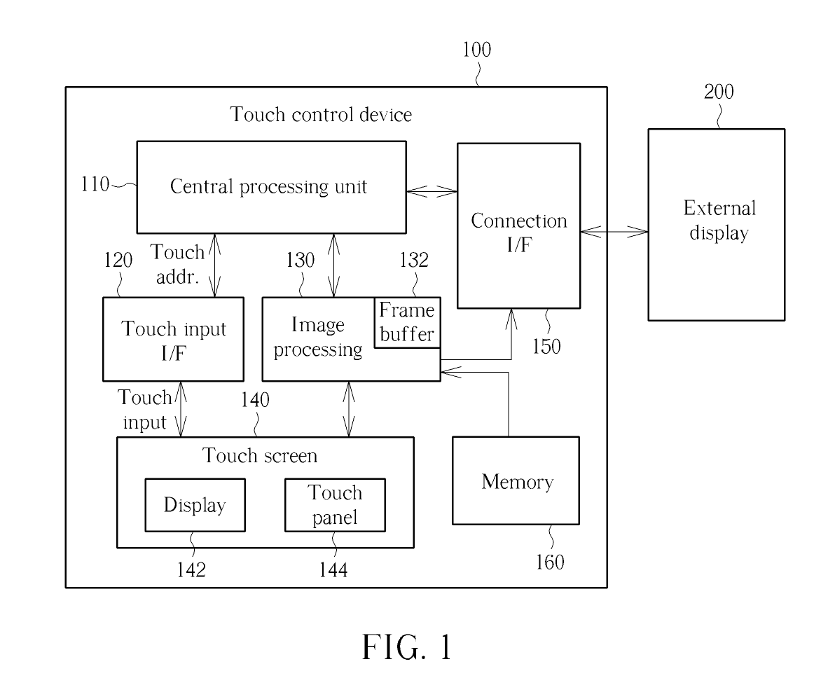

Please refer to FIG. 1. FIG. 1 is a functional block diagram showing a touch control device 100 of the present invention. The touch control device 100 comprises, among others, a central processing unit 110, a touch input interface unit 120, an image processing unit 130, a display unit 140 and a memory unit 160. The central processing unit 110 is configured to execute various programs/applications, including the operating system of the touch control device 100. The central processing unit 110 may also receive various events/signals from other components of the touch control device and perform corresponding operations. The touch input interface unit 120 is coupled to the display unit 140 and configured to receive input signals from the display unit 140 and transmit to the central processing unit 110 for processing. The touch screen unit 140 comprises at least a display module 142 and a touch panel 144. The display module 142 is configured to display images to the users and the touch panel unit 144 is configured to receive touch inputs from the users. The user input may be a touch control signal corresponding to certain position of the touch screen unit 140. The touch screen unit 140 provides the coordinate of the touch input to the touch input interface unit 120. The touch input interface unit 120 receives the touch input signal and converts it into corresponding touch address event according to the touch coordinate.

The touch input interface unit 120 then transmits the touch address event to the central processing unit 110. According to the touch address event, the central processing unit 110 performs corresponding operation, such as refreshing the display images and others. The image processing unit 130 is configured to process images to be displayed on the touch screen unit 140. The image processing unit 130 may retrieve source images from various sources, such as the memory unit 160 or from a remote entity via the connection interface unit 150, and performs corresponding operations. For example, the image processing unit 130 may combine several source images to produce a final display image. The image processing unit 130 also comprises a frame buffer 132 for providing display images to the touch screen unit 140. The frame buffer 132 may be configured as a ring buffer with limited size. The touch control device 100 is connected to an external display device 200 via the connection interface unit 150. The connection interface unit 150 may support USB, HDMI, VGA, Wi-Fi, Bluetooth and/or other suitable connection protocol. Upon connection to the external display device 200, the connection interface unit 150 also provides information related to the external display device 200 to the central processing unit 110, such as identity information, supported resolutions, supported formats and/or pothers. Display images in the frame buffer 132 may be transmitted to the external display device 200 via the connection interface unit 150.

In the present invention, the touch control device 100 has two display modes for displaying images on the internal touch screen unit 140 or the external display device 200. When the touch control device 100 operates in normal display mode, the images processing unit 130 provides display images to the display module 142 of the touch screen unit 140, and the central processing unit 110 receives touch control inputs via the touch panel 144 of the touch screen unit 140. In this mode, the touch screen unit 140 functions as the main display interface and control interface to the users. When the touch control device 100 is connected to the external display device 200, the touch control device 100 may operate in external display mode which images are displayed on the external display device 200. The image processing unit 130 provides display images to the external display device 200 via the connection interface unit 150. Furthermore, the image processing unit 130 may be configured to add a cursor or graphical icon, which is not appeared in the normal mode, on the display images. The cursor or graphical icon may be stored in the memory unit 160 and be accessed in external display mode. Upon the external display mode is enabled, the image processing unit 130 accesses the cursor or graphical icon image from the memory unit 160. The cursor or graphical icon is added by overlaying the cursor image onto the original display image at a specific position, which may be designated by user input or predefined. In this mode, the touch control device 100 may disable the display module 142 of the touch screen unit 140 without providing the display images to the touch screen unit 140. And the touch screen unit 140 may only serve to receive touch input from the touch panel 144. The touch panel 144 may receive touch input for controlling the cursor on the display image, for example, moving position of the cursor or selecting related content pointed by the cursor.

In one embodiment of the invention, the touch control device 100 may first operate in normal display mode. In response to the connection interface unit 150 detecting connection to the external display device 200, the connection interface unit 150 may send a signal, such as an interrupt, to notify the central processing unit 110 that an external display device is available for use. The central processing unit 100 then switches from normal display mode to external display mode, and instructs the image processing unit 130 to provide display images with cursor or graphical icon to the external display device 200. The connection interface unit 150 also provides information related to the external display device 200 to the central processing unit 110, for example, device identity, supported display resolutions and/or other information. The central processing unit 110 may pass the information to the image processing unit 130 so that the image processing unit 130 can generate the display images in proper format and/or resolution. The image processing unit 130 may apply the cursor icon or graphical icon onto the display images and adjust the size and/or resolution of the display images outputted to the external display device 200 accordingly. Furthermore, the image processing unit 130 may determine which icon to be applied according to the application corresponding to currently displayed images. For example, a cursor icon is added when the content of the display image is a webpage or text file, and a virtual keyboard may be added when the cursor icon moves to a text input field.

The touch panel 144 of the touch screen unit 140 may receive touch input from users, such as using fingertip or stylus. The touch input is transmitted as an address signal indicating touch position of corresponding touch input. The touch input interface 120 may constantly monitor the position of the touch input, and the image processing unit 130 then updates position of the cursor icon in the display image accordingly. Similarly, the image processing unit 130 may refresh the display images according to the operation corresponding to the touch input. For example, if user performs a tap on a link within the webpage, the central processing unit 110 may direct to another webpage of the link and loads its content, the image processing unit 130 may access the content, add the cursor on the new display image and refresh the frame buffer 132 with the new display image for output.

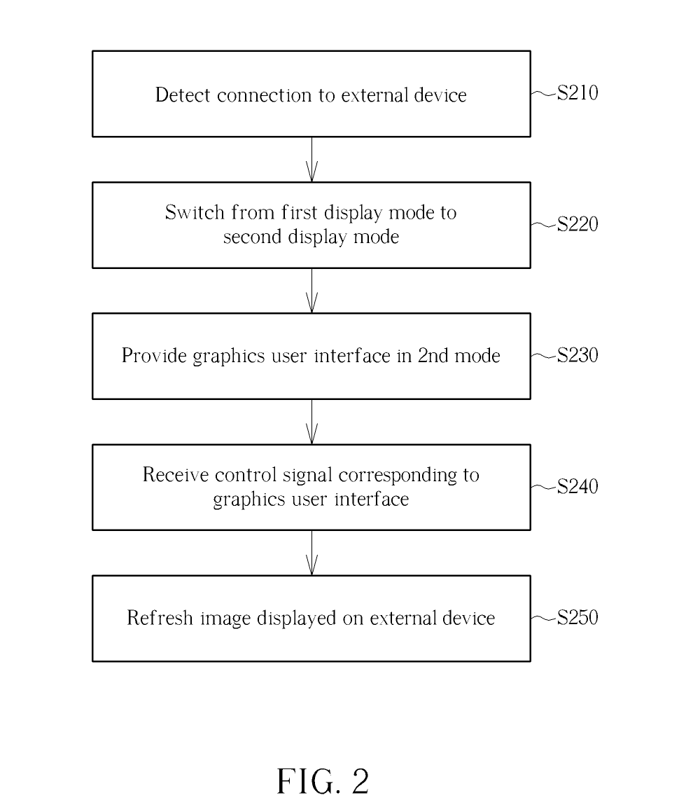

Next please refer to FIG. 2 which illustrates a method for displaying images of a touch control device on an external display device according to an embodiment of the invention. First in step S210, the touch control device detects connection to an external display device. The connection may be wired or wireless connection such as USB, HDMI, Wi-Fi, Bluetooth and/or others. In response to connection is detected, the touch control device switches from a first display mode to a second display mode in step S220. In the first display mode, display images are only provided to internal display unit, while in the second mode display images are provided to the connected external display device. Also the internal display unit may be disabled for saving power consumption in the second display mode. Then in step S230, a graphics user interface is provided to the display image in the second display mode. The graphics user interface may be a cursor icon or other graphics icon. The display image along with the cursor icon is displayed on the external display device. In step S240, a control signal corresponding to the graphics user interface is received from the touch panel of the touch control device. The touch input on the touch panel is converted to corresponding control signal according to the touch position and application currently running. For example, the touch position may be mapped to an operation of the application. According to the control signal, the display image is refreshed and provided to the external display device in step S250.

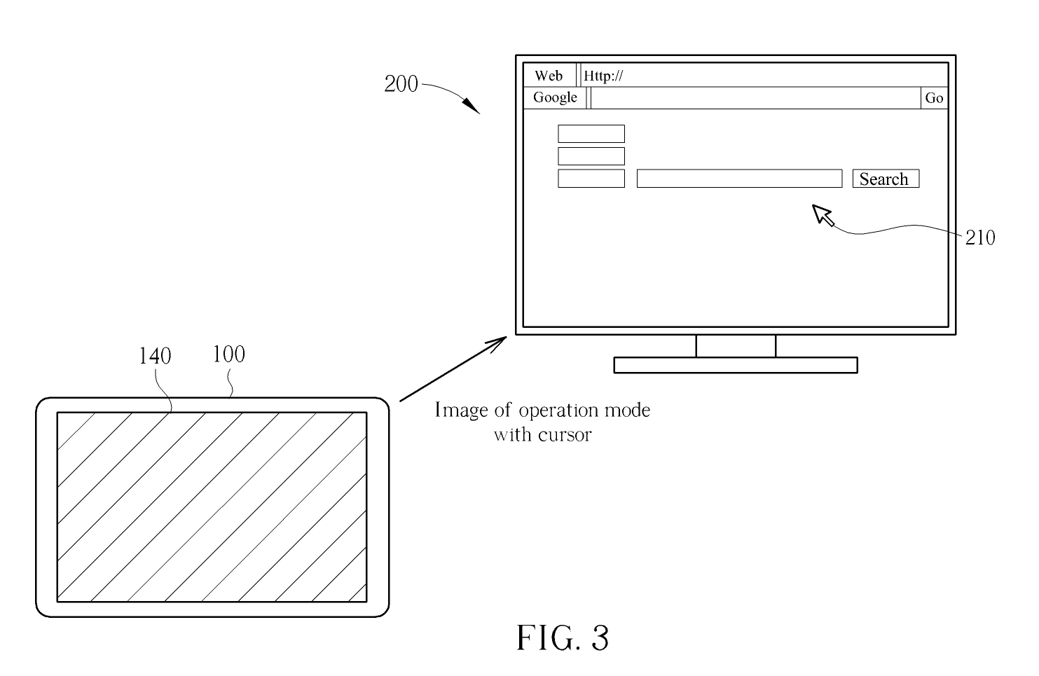

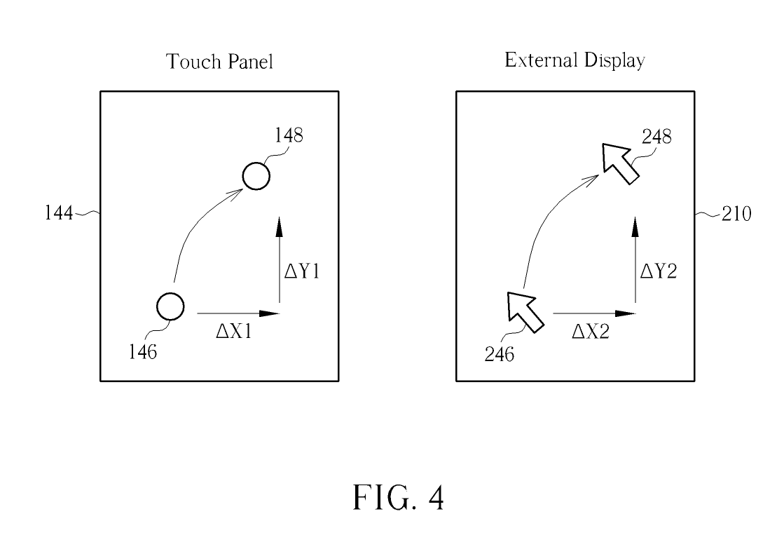

FIG. 3 illustrates an embodiment of display images in external display mode of the invention. In the embodiment of FIG. 3, a cursor icon 210 originally not provided in internal display mode is added on the display image of the external display device 200. The touch screen unit 140 of touch control device 100 is used as a control interface for controlling the cursor icon 210. When user moves his/her finger, for example, on the touch panel 144, the cursor 210 moves its position along with the movement of the finger. FIG. 4 illustrates an embodiment of controlling display images in external display mode. Assume that the original position of the cursor icon 210 is at position 246 and the touch panel 144 receives a touch input at position 146. The position 146 of the touch panel 144 is mapped to the position 246 of the cursor icon 210 in the displayed image. When the touch input moves from position 146 to position 148, the cursor icon 210 is moved from position 246 to position 248 accordingly. As described above, the touch panel 144 provides touch input signal to the touch input interface unit 120. The touch input signal may comprise information of the touch input position, such as absolute address. The information is provided to the central processing unit 110 and the central processing unit 110 may calculate the address offset of touch input positions. The address offset of touch input positions is then converted into display offset of cursor positions. The central processing unit 110 may calculate the display offset of cursor positions according to the address offset of touch input positions and the resolution of the display images on the external display device 200. Then the display offset of cursor position is provided to the image processing unit 130 to refresh the display image. The image processing unit 130 may refresh the display image by updating the position of the cursor image overlaying on the original image. In another embodiment of the invention, the touch input signal may be converted into a command for performing certain operation by the central processing unit 110, and the image processing unit 130 may refresh the display image by loading new images corresponding to the command. Yet in another embodiment of the invention, the cursor icon 210 may be removed in response to the cursor position corresponding to specific region of the display images, such as border of the display images, and be added back again in response to the cursor position is changed back to normal region of the display images.

In the embodiment of FIG. 4, the touch input position may be updated to the central processing unit 110 periodically so as to reduce the latency of cursor position update. Address offsets of the touch input positions between two time points are calculated in x and y dimensions separately, denoted as ΔX1 and ΔY1. A ratio R is applied to the address offsets according to resolution of the display image or it may be predefined. Similarly, different ratios Rx, Ry may be used for x and y dimensions respectively. The display offsets of cursor positions are then calculated by multiplying R (or Rx, Ry) with ΔX1 and ΔY1 so as to obtain ΔX2 and ΔY2. The new position 248 can be thus determined by adding ΔX2 and ΔY2 to position 246, which means moves the cursor ΔX2 in x direction and ΔY2 in y direction.

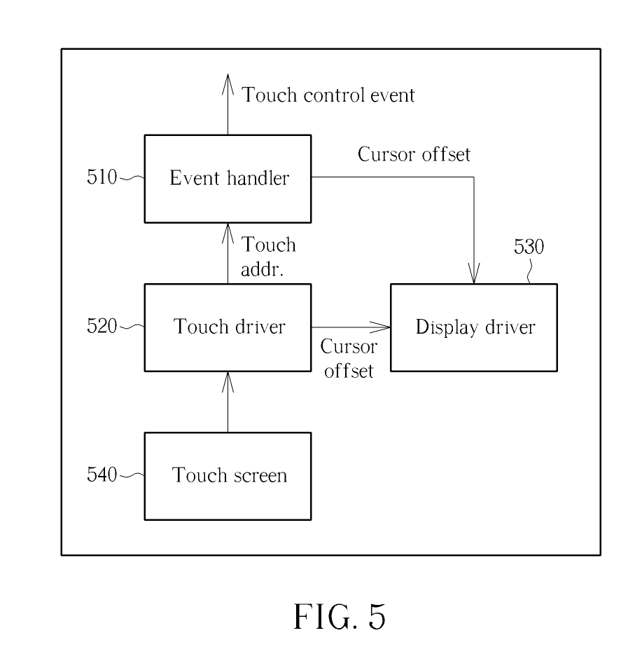

FIG. 5 illustrates a block diagram of a touch control device according to an embodiment of the invention. The touch control device 500 comprises, among others, an event handler 510, a touch screen driver 520, a display driver 530 and a touch screen unit 540. The touch screen unit 540 is configured to display images to a user and receive touch input from the user. The touch input signal, which comprises an absolute address, is sent to the touch driver 520. Consequently, the touch driver 520 converts the touch input into a touch address event, which also comprises the absolute address and sends the touch address event to the event handler 510. The event handler 510 is configured to convert the touch address event to a touch control event for performing certain operation corresponding to the content at the position of the touch input. For example, if the touch input corresponds to a position where the content is a playback link, the touch control event would comprise a command for loading a video and playing back. The operation of the touch control event is processed by the central processing unit 110. The event handler 510 would send to touch control event to related components to execute the command. In the example of above, the event handler 510 may instruct a video processing unit to access the video file, decode the video file, and send decoded video file to the touch screen unit 540. The event handler 510 may also be configured to convert the absolute address to a cursor address and send to the display driver 530 so as to update the cursor position.

In another embodiment of the invention, the touch driver 520 is configured to send the touch address event to the event handler 510, and convert the absolute address into cursor address and provide to the display driver 530. The display driver 530 is configured to refresh display image and change the overlaying cursor image to designated cursor position according to the cursor address. The cursor address can be calculated according to the embodiment of FIG. 4. Yet in another embodiment of the invention, the display driver 530 may add the cursor image by blending it with the original image with predefined transparency (from 1 to 0). In one embodiment of the invention, the event handler 510 is implemented in the central processing unit 110 of FIG. 1, the touch driver 520 is implemented in the touch input interface unit 120, the display driver 530 is implemented in the image processing unit 130 of FIG. 1. Please note that these units/components may be implemented in hardware, logic gates, software program code, or combination of above.

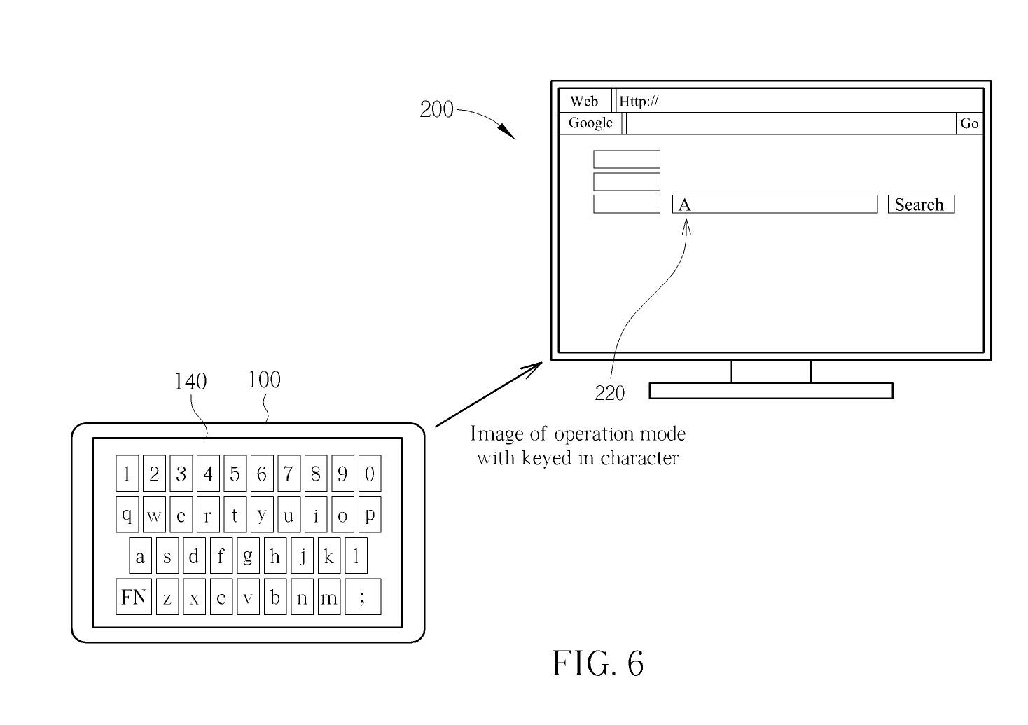

FIG. 6 illustrates another embodiment of display images in external display mode of the invention. In this embodiment, when the cursor is moved to a position that allows text input, the display unit 140 of the touch control device 100 may be configured to display a virtual keyboard automatically. As a result, user needs not to activate the virtual keyboard manually and the virtual keyboard would not be displayed on the external display device 200 to provide a clear view. With reference back to FIG. 5, the touch driver 520 converts the touch input into a touch address event comprising a command to launch a virtual keyboard on the touch screen unit 540. Upon receiving the touch address event, the event handler 510 instructs the display driver 530 to provide the virtual keyboard to the touch screen unit 540 meanwhile update the cursor position shown on the external display device 200. Later if other touch input corresponds to a position of a character shown on the keyboard is received, for example capital A, the touch driver 520 sends a touch address event of typing A to the event handler 510. The event hander 510 then instructs the display driver to update the display image with A in the text field by corresponding touch control event.

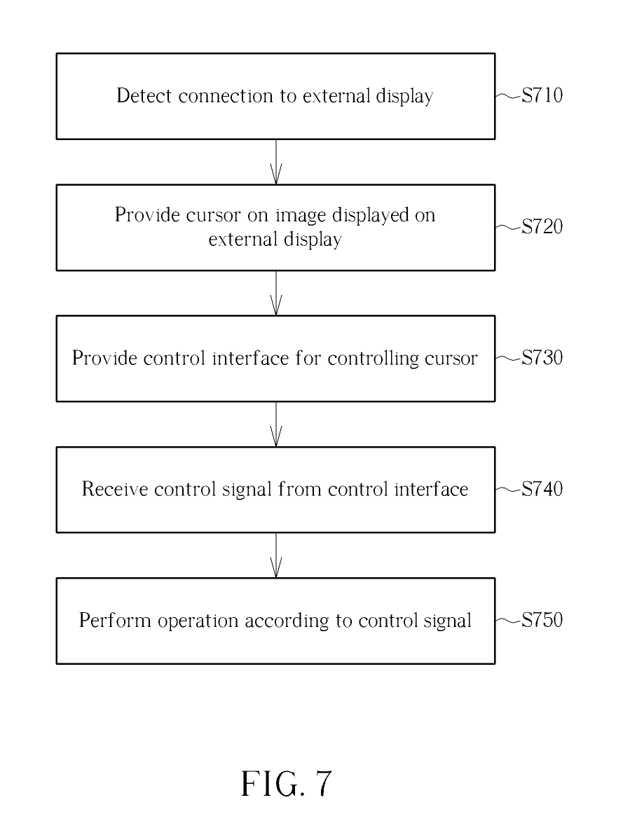

Now please refer to FIG. 7 which illustrates a method for displaying images of a touch control device on an external display device according to an embodiment of the invention. The method may be implemented in the touch control device 100 of FIG. 1. In step S710, the touch control device detects whether the external display is connected. The detection may be performed by monitoring an interrupt from the connection interface unit is received, and the connection may be a hot-plug connection. In response to the connection is detected, a cursor icon is provided on an image and the image with the cursor icon is displayed on the external display device in step S720. Meanwhile, the internal display unit of the touch control device may be disabled. Next in step S730 a control interface is provided for controlling the cursor displayed on the external display device. The control interface may be the touch panel of the touch control device. In one embodiment of the invention, the internal display unit may be configured to provide graphics user interface for directing user to use the control interface. The control interface is used to receive control signal inputted by a user in step S740. For example, user may use finger or stylus to input control signals for controlling the position of the cursor. Then in step S750, the touch control device performs operation according to the control signal. In the above example, the touch control device may update the cursor position according to the finger trace (control signals) received by the control interface.

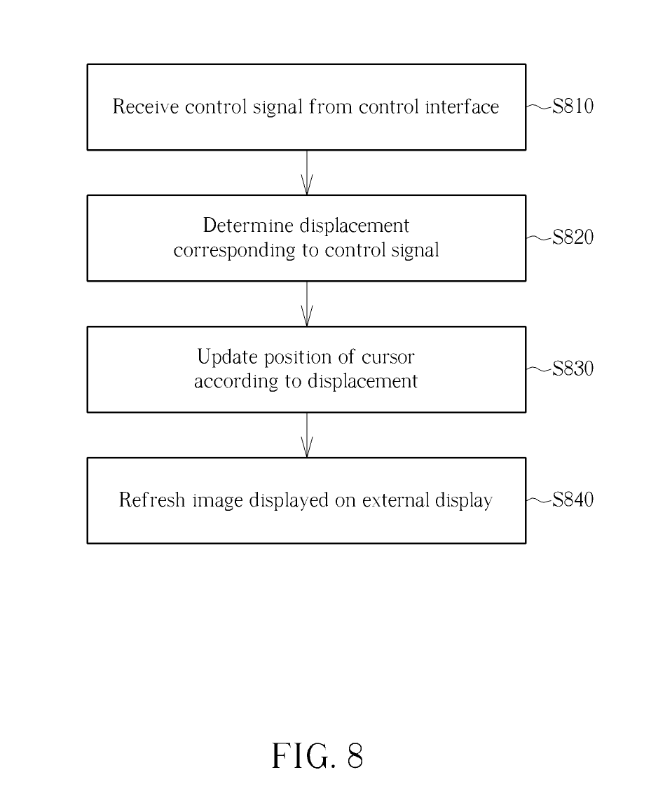

FIG. 8 depicts a method for displaying images of a touch control device on an external display device according to another embodiment of the invention. The touch control device may be connected to an external display device via wired or wireless connection and the connection may be built by hot-plug. The method can be implemented in the touch control device of FIG. 5. First in step S810, a control signal is received from a control interface of the touch control device. The control interface is a touch control interface such as a touch panel. The control interface may receive control signals from various input tools, such as finger or stylus, and monitor the control signals periodically. The control signals are sent to a touch input interface unit for converting into corresponding control events. Then the displacement corresponding to the control signal is determined in step S820. The displacement may correspond an address offset of the input tool at different time points, and be determined by the touch input interface unit or an event handler executed by the central processing unit of the touch control device. The displacement may be calculated as a cursor offset according to the address offset and the resolution of the external display device. For example, the cursor offset may be multiplication result of the address offset and a ratio defined according to resolution. Once determined, the displacement is provided to the display driver of the touch control device. Next position of the cursor is updated according to the displacement, in step S830. The display driver may update the cursor image overlaying on the display image from one position to another according to the displacement. And the image is refreshed and provided to the external display device in step S840. Please note that in another embodiment of the invention, the position of the cursor is updated by overlaying to cursor image with a new display image, for example loading a new webpage. Yet in another embodiment of the invention, the cursor may be enabled or disabled depending on the application currently running. For example, if the touch control device switches to run a gaming application, the cursor may not appear even when external display device is connected.

In contrast to the prior art, the present invention provides a method for displaying images of the touch control device on the external display device. The touch control device of the present invention can be converted to an input device when the image of the operation mode of the touch control device is displayed on the external display device, so as to increase convenience during use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying images of a touch control device on an external display device, comprising:
providing a graphical icon on the image displayed on the external display device;
providing a control interface for controlling the graphical icon on the touch control device;
receiving a control signal from the control interface; and
performing an operation corresponding to the control signal.

2. The method of claim 1, further comprising:
detecting a connection to the external display device;
wherein the graphical icon is provided in response to the connection being detected.

3. The method of claim 2, wherein the detecting further comprises determining a resolution of the external display device.

4. The method of claim 3, wherein the providing of graphical icon further comprises adjusting the graphical icon according to at least one of the following: resolution of the external display device and an application corresponding to the image displayed.

5. The method of claim 1, wherein the receiving of control signal further comprises
determining a displacement of an input tool on the control interface corresponding to the control signal; and
updating position of the graphical icon on the display image according to the displacement.

6. The method of claim 5, wherein the control interface is a touch screen and the input tool is one of the following: finger-tip, stylus.

7. The method of claim 5, wherein the position of the graphical icon is updated according to the displacement of the input tool and a resolution of the external display device.

8. The method of claim 1, wherein the performing of operation comprises refreshing the image displayed on the external display device.

9. The method of claim 7, wherein in response to the control signal corresponding to selecting another application, the external display device is refreshed with another image corresponding to the application.

10. A touch control device, comprising:
a touch input interface unit, configured to receive a touch input;
a processing unit, configured to process a control signal corresponding to the touch input; and
an image processing unit, configured to provide an image displayed with a graphical icon;
wherein the graphical icon is controlled according to the control signal.

11. The touch control device of claim 10, further comprising:
a connection interface unit, configured to detect connection to an external device;
wherein the image with the graphical icon is displayed on the external device in response to the connection is detected.

12. The touch control device of claim 11, the processing unit is further configured to disable a display module within the touch input interface unit in response to the connection is detected.

13. The touch control device of claim 10, wherein the processing unit is further configured to control a position of the graphical icon within the image displayed according to the control signal and a display resolution of the external device.

14. The touch control device of claim 13, wherein the position of the graphical icon is updated according to a displacement of the touch input on the touch input interface unit.

15. The touch control device of claim 10, wherein the processing unit is configured to perform an operation corresponding to the control signal, and the image processing unit is configured to refresh the image displayed according to the application.

16. The touch control device of claim 10, further comprising:
a memory unit configured to store the graphics icon.

17. A method for displaying images of a touch control device on an external display device, comprising:
detecting a connection of the touch control device to the external device; and
switching from a first display mode to a second display mode for displaying an image on the external device in response to the connection being detected;
wherein the second display mode provides additional graphics user interface not supported in the first display mode.

18. The method of claim 17, further comprising:
receiving a control signal corresponding to the additional graphics user interface in the second display mode; and
refreshing the image displayed on the external display device according to the control signal.

19. The method of claim 17, wherein the additional graphics user interface is a cursor.

20. The method of claim 17, wherein the additional graphics user interface is provided according to an application currently running on the touch control device.
